(19) United States
(12) Patent Application Publication
(10) Pub. No.: US 2006/0181556 A1
(43) Pub. Date: Aug. 17, 2006

(54) Read/write processing device

(75) Inventors: Hiroshi Wanibuchi, Nagano (JP); Katsuyuki Kondo, Nagano (JP)

Correspondence Address: EDWARDS & ANGELL, LLP, P.O. BOX 55874, BOSTON, MA, 02205, US

(73) Assignee: Seiko Epson Corporation, Tokyo (JP)

(21) Appl. No.: 11/337,138

(22) Filed: Jan. 20, 2006

(30) Foreign Application Priority Data
Jan. 21, 2005 (JP) P2005-014152

(51) Int. Cl. B41J 25/308

(52) U.S. Cl. 347/8

(57) ABSTRACT

A read/write processing device including: a transport path, adapted to transport a medium therethrough; a read/write unit, adapted to read or write data on the medium and provided at a part of the transport path; a transport mechanism, provided with a first feeding roller and a pressing member adapted to transport the medium to the read/write unit while the pressing member presses the medium toward the first feeding roller; a gap adjusting mechanism, operable to adjust a gap between the read/write unit and the medium in the trasnsport path; a medium release mechanism, operable to release the mdium from the first feeding roller and the pressing member; a detector, operable to detect a jam of the medium in the transport path; and a controller, operable to control the gap adjusting mechanism to wide the gap, when the detector detects the jam.

### TECHNICAL FIELD OF THE INVENTION

Embodiments of the present invention relate to a read/write processing device which transports a paper along a predetermined transport path and performs an information process on the paper carried onto a process reference surface in the transport path, such as a process of forming desired information on the paper or reading the information of the paper.

### BACKGROUND OF THE INVENTION

A printer connected to a personal computer or the like is an example of a read/write processing device which transports a paper along a predetermined transport path and performs an information process on the paper carried onto a process reference surface in the transport path.

In such a printer, a paper feed unit for laminating the papers therein, a transport mechanism for transporting the sheet from the paper feed unit along a predetermined transport path one by one, a print head (process mechanism) which prints an image such as a character or a figure on the surface of the sheet carried onto a platen surface (process reference surface) disposed in the transport path, and various operating mechanisms such as a carriage for applying a predetermined moving force to the print head are mounted in an outer case.

In another printer, in order to reduce the size of the read/write processing device or save space, a front feed/ejection type, in which any one of a paper feed unit and a unit of ejecting a printed sheet is disposed at the front side of the apparatus, is variously suggested (for example, see Japanese Patent No. 3520469).

In such a front feed/ejection type printer, a sheet cassette laminating the sheets therein is disposed at the lower side of the front surface of the apparatus, an ejection tray for ejecting a printed sheet is disposed above the sheet cassette, a U-shaped transport path for connecting the sheet cassette with the ejection tray is formed in the outer case, a platen surface is disposed in a linear transport path configuring the U-shaped transport path, and a print head is disposed above the platen surface.

In addition, in the U-shaped transport path of the front feed/ejection type printer, a paper feed roller and a driven roller which sandwich and transport a sheet for transporting the sheet to the platen surface disposed at the downstream side of the transport path, an intermediate roller and an assist roller for sandwiching and transporting the sheet fed into the transport path to the paper feed roller and the driven roller, a print head for printing the sheet carried onto the platen surface, and a ejection roller and a star wheel for ejecting the sheet printed by the print head onto the ejection tray located at the outlet of the transport path are provided.

Furthermore, in another printer, a gap between the rollers sandwiching the sheet can be adjusted by, for example, a gap adjusting mechanism for adjusting a gap between the platen surface and the print head, or the paper feed roller and the driven roller on the transport path, such that a stable print is performed with respect to various media such as general paper, thick paper such as a postcard, or CD-R (for example, see JP-A-2003-266856, JP-A-2002-356036, and JP-A-5-309909).

However, in a case of the front feed/ejection type printer, in order to remove the paper jam in the transport path, a transport path opening/closing mechanism for opening and closing a portion of the transport mechanism configuring the U-shaped transport path is provided, and, when the paper jam is generated, at least a portion of the jammed sheet is externally exposed by opening the transport path opening/closing mechanism.

However, in a case where the transport path opening/closing mechanism for externally exposing a portion of the jammed sheet is provided as a solution for removing the paper jam in the printer, the jammed sheet may not be easily removed and thus another problem may be generated.

In other words, since a portion of the jammed sheet is sandwiched between a pair of rollers in the transport path, it may be difficult to pull out the sheet with a small force. Furthermore, if the jammed sheet is forcibly pulled out, a portion of the sheet sandwiched between the pair of rollers tears, a piece of sheet remains in the transport path, and thus another problem is caused in a next transporting process.

In addition, in a case where a portion of the jammed sheet is disposed between the print reference surface and the print head, when the jammed sheet is pulled out, the sheet rubs against the print head and thus the print head may be damaged or contaminated.

Furthermore, when the jammed sheet is pulled out, if a driving roller of the pair of rollers rotates by a friction force with the sheet, the rotation of the driving roller reversely drives a power transmission system, a rotation force is applied to a driving motor, and a power generation phenomenon of the driving motor is generated. Thus, circuits may be damaged by the power generation of the driving motor.

Meanwhile, when a mechanism for removing the paper jam is newly provided in order to prevent the above-mentioned problems from being generated, the cost increases due to the complexity of the configuration.

### SUMMARY OF THE INVENTION

Accordingly, in order to solve the above-mentioned problems, an object of at least one embodiment of the present invention is to provide a read/write processing device, which can easily remove a jammed paper when a paper jam is generated in the device, although a mechanism for removing the jam is not further provided. The embodiments of the present invention is as follows:

A read/write processing device comprising:

a transport path, adapted to transport a medium therethrough;

a read/write unit, adapted to read or write data on the medium and provided at a part of the transport path;

a transport mechanism, provided with a first feeding roller and a pressing member adapted to transport the medium to the read/write unit while the pressing member presses the medium toward the first feeding roller;

a gap adjusting mechanism, operable to adjust a gap between the read/write unit and the medium in the trasnsport path;

a medium release mechanism, operable to release the mdium from the first feeding roller and the pressing member;

a detector, operable to detect a jam of the medium in the transport path; and
a controller, operable to control the gap adjusting mechanism to wide the gap, when the detector detects the jam. According to the read/write processing device having the above-mentioned configuration, when the paper jam is generated in the device, the gap adjusting mechanism automatically operates to widen the gap between the process reference surface and the read/write unit.

Furthermore, since the gap adjusting mechanism, which automatically operates when the paper jam is generated, can process the papers having different thicknesses as well as remove the paper jam, a mechanism for removing the paper jam need not be further provided and thus the protection of the read/write unit at the time of removing the jammed paper can be realized with low cost.

A read/write processing device comprising:

a transport path, adapted to transport a medium therethrough;

a read/write unit, adapted to read or write data on the medium and provided at a part of the transport path;

a transport mechanism, provided with a first feeding roller and a pressing member adapted to transport the medium to the read/write unit while the pressing member presses the medium toward the first feeding roller;

a medium release mechanism, operable to release the medium from the first feeding roller and the pressing member;

a detector; operable to control the medium release mechanism to release the medium, when the detector detects the jam.

According to the read/write processing device having the above-mentioned configuration, when the paper jam is generated in the device, the roller release mechanism automatically operates to release the medium from the driven roller and the paper feed roller such that the sandwiching of the paper is opened.

According to read/write processing device according to the present invention, when a paper jam is generated in the device, the gap adjusting mechanism or the roller release mechanism automatically operate, and thus the gap between the process reference surface and the process mechanism widens or the driven roller is separated from the paper feed roller such that the sandwiching of the paper is opened. Accordingly, when a transport path opening/closing mechanism is opened and the jammed paper is pulled out, the contamination of the read/write unit generated when the jammed paper rubs against the process mechanism is not generated, or a piece of sheet does not remain in the apparatus when a portion of the jammed paper is pulled out. In addition, it is possible to easily remove the jammed paper with a small operation force.

Thus, it is possible to provide a read/write processing device having excellent treatment and repairability, which can easily remove the jammed paper when the paper jam is generated in the device, although a mechanism for removing the paper jam is not further provided.

### BRIEF DESCRIPTION OF THE DRAWINGS

FIG. 1 is a perspective view of an inkjet printer according to a first embodiment of the present invention.

FIG. 2 is a perspective view of the inkjet printer illustrated in FIG. 1 in which an ejection tray and an upper case are removed.

FIG. 3 is a perspective view of the inkjet printer illustrated in FIG. 2 when viewed at the upper rear side thereof.

FIG. 4 is a side cross-sectional view illustrating a sheet transport path in the inkjet printer illustrated in FIG. 1.

FIG. 5 is a side cross-sectional view illustrating a feed state of the inkjet printer illustrated in FIG. 1.

FIG. 6 is a side cross-sectional view illustrating a state of transporting the sheet in the inkjet printer illustrated in FIG. 1.

FIG. 7 is a side cross-sectional view of main portions of the sheet transport path in the inkjet printer illustrated in FIG. 1.

FIG. 8 is a side cross-sectional view explaining a state of normally transporting the sheet in the transport path illustrated in FIG. 7.

FIG. 9 is a side cross-sectional view explaining an operation of a gap adjusting mechanism when a paper jam is generated in the transport path illustrated in FIG. 8.

FIG. 10 is a side cross-sectional view explaining a state of blocking power transmission between a driving motor and an intermediate roller in the transport path illustrated in FIG. 9.

FIG. 11 is a flowchart illustrating an operation of the inkjet printer illustrated in FIG. 1 when a paper jam is generated.

### DETAILED DESCRIPTION OF THE INVENTION

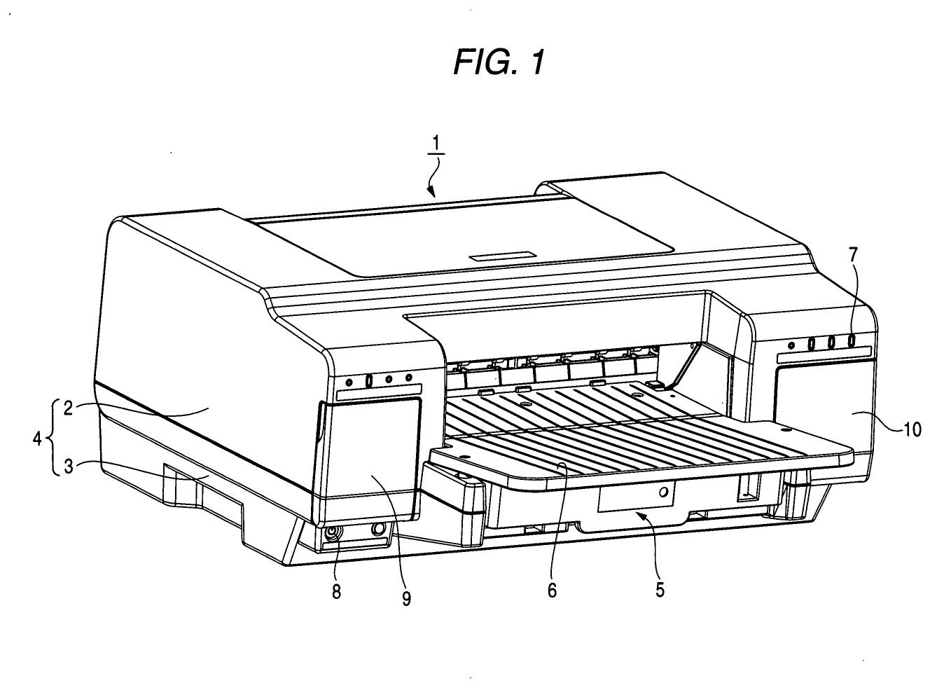

Hereinafter, a read/write processing device according to a first embodiment of the present invention will be described with reference to the accompanying drawings. In the present embodiment, although, for example, an inkjet printer 1 illustrated in FIG. 1 is described as a paper processing device, as the read/write processing device according to the present invention, for example, printers including a wire dot printer, a copier, a facsimile, a paper money changing machine or the like may be used, in addition to the printer.

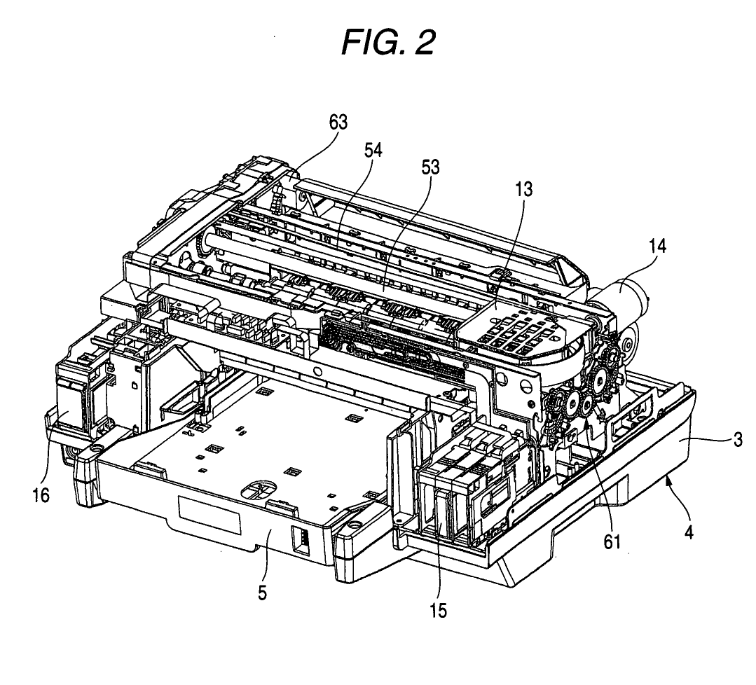

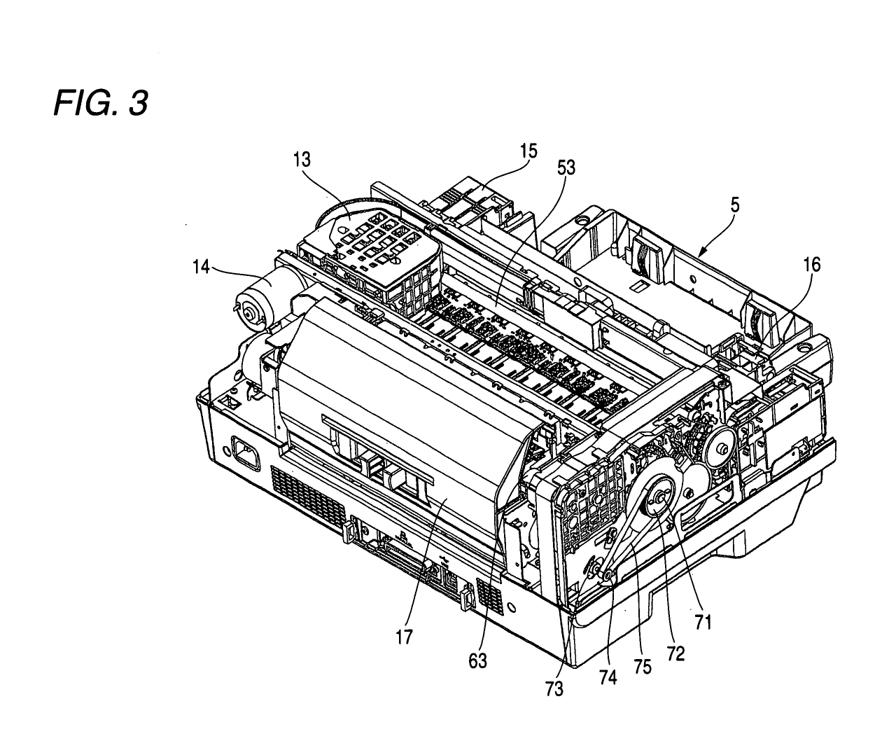

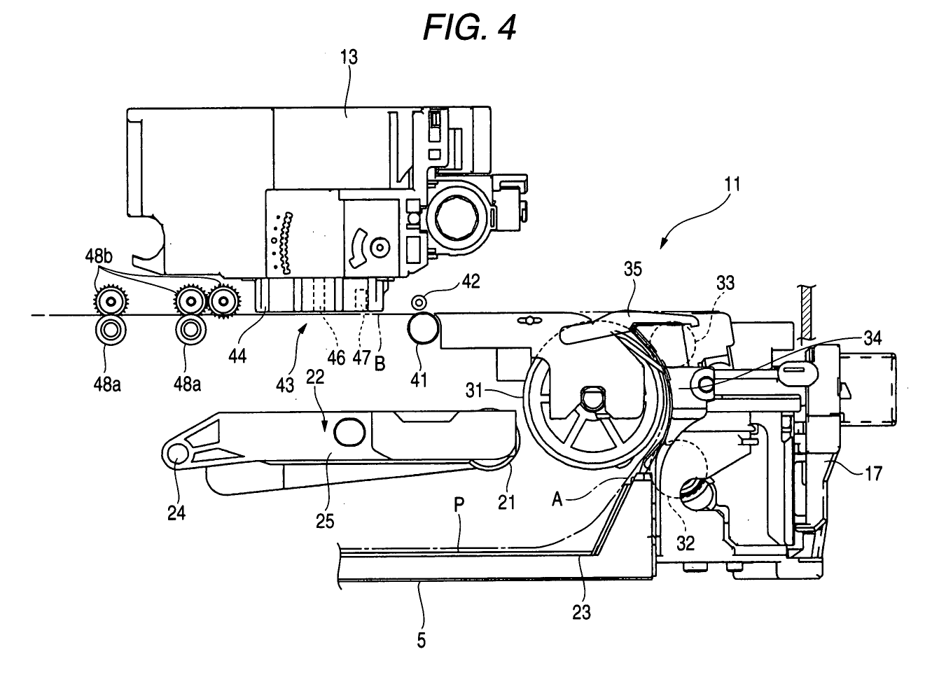

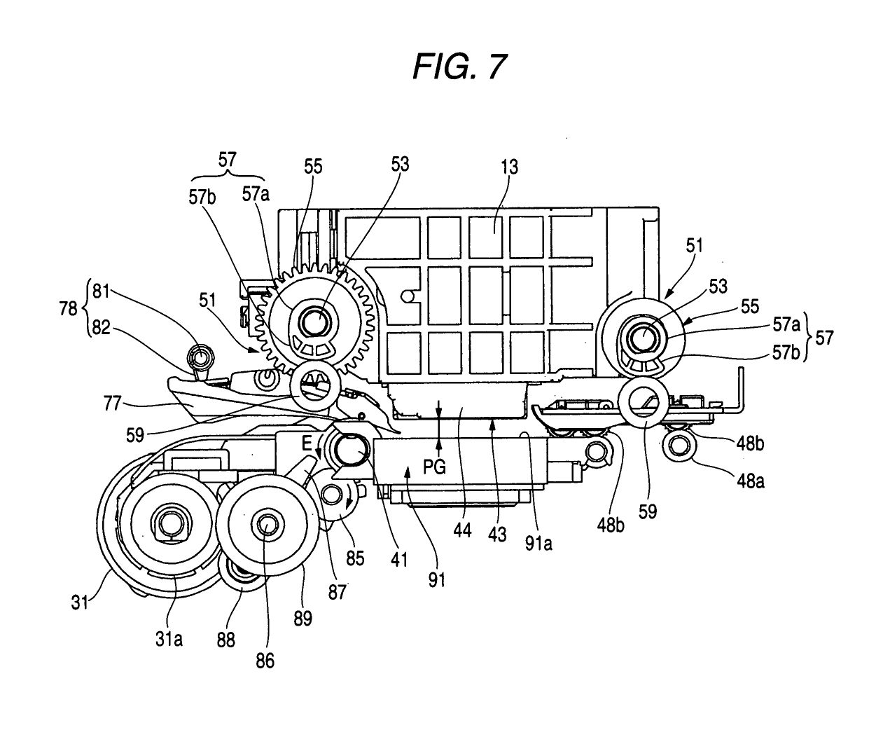

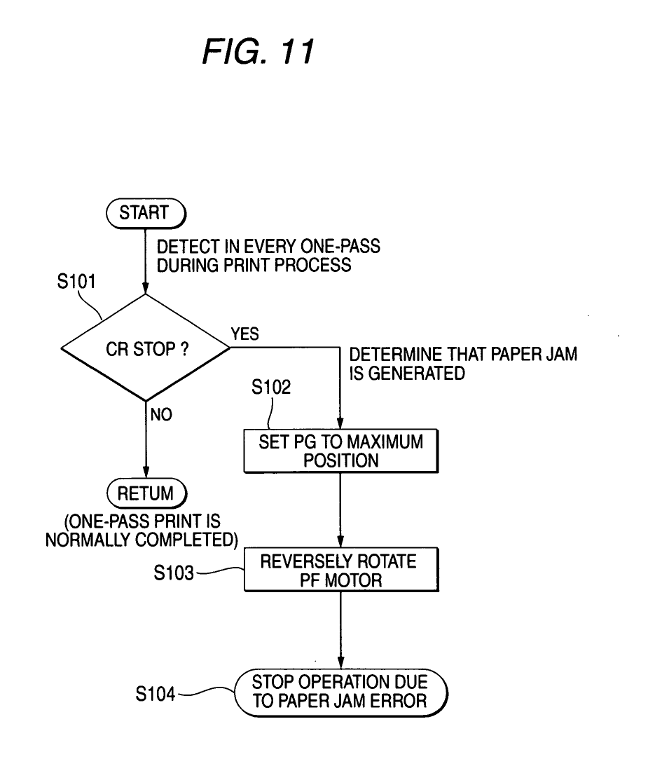

FIG. 1 is a perspective view of an inkjet printer according to a first embodiment of the present invention. FIGS. 2 and 3 are perspective views of the inkjet printer illustrated in FIG. 1 in which an ejection tray and an upper case are removed. FIGS. 4 through 6 are side cross-sectional views illustrating a sheet transport path in the inkjet printer illustrated in FIG. 1. FIGS. 7 through 10 are side cross-sectional views of main portions of the sheet transport path in the inkjet printer illustrated in FIG. 1, and FIG. 11 is a flowchart illustrating an operation of the inkjet printer illustrated in FIG. 1 when a paper jam is generated.

The inkjet printer 1 according to the present embodiment is a front feed/ejection type printer. As illustrated in FIG. 1, a box-shaped sheet cassette 5 for laminating papers P therein is detachably inserted into the center of the front surface of an outer case 4 including an upper case 2 and a lower case 3.

In addition, an ejection tray 6 for receiving a printed sheet is provided to cover an upper opening portion of the sheet cassette 5.

Furthermore, a display unit 7 such as an indicator and an operational unit 8 such as a power supply switch are disposed at the left and right sides of the front surface of the outer case 4. A black ink cartridge mounting unit and a color ink cartridge mounting unit, which are disposed at the left and right sides of the front surface of the outer case 4, are covered by a black ink cover 9 and a color ink cover 10 which are freely opened or closed, respectively.

In the outer case 4, as illustrated in FIGS. 2 to 4, a transport mechanism 11 which transports a sheet of paper P which is introduced from the sheet cassette 5 one by one by a pickup roller (feed roller) 21 of a below-described feed unit 22 along a U-shaped transport path, a carriage 13 which is disposed to be reciprocally moved by the transport mechanism 11 in a direction perpendicular to a transporting direction of the sheet P in the U-shaped transport path, a print head (read/write unit) 44 which is mounted in the carriage 13 and performs print (information process) by injecting particles of a recording ink onto the sheet P, ink tanks 15 and 16 for storing the recording inks which are supplied to the print head 44, and a control unit CPU (not illustrated) which controls a transporting speed of the sheet P due to the transport mechanism, a movement speed of the carriage 13, or an ink injecting operation of the print head 44 are provided.

The carriage 13, as illustrated in FIGS. 2 and 3, is supported to be moved in a width direction of the sheet by a pair of carriage shafts 53 which extend in the width direction of the sheet, and fixed to a timing belt 54 which is driven by a carriage motor 14, such that the carriage can be reciprocally moved in the width direction of the sheet in accordance with the travel of the timing belt 54.

In the inkjet printer 1, ink discharge from the print head 44 mounted in the carriage 13 is controlled to record (print) an image such as a character or a figure on the sheet P, in the state that the transporting direction of the sheet P is set to a sub scan direction and the movement direction of the carriage 13 is set to a main scan direction.

In the inkjet printer 1 according to the present embodiment, the U-shaped transport path in which the sheet P is transported by the transport mechanism 11, as illustrated in FIG. 4, includes an arc-shaped transport path A for transporting the sheet P introduced from the sheet cassette 5 and a linear transport path B connected from the arc-shaped transport path A to an ejection tray 6.

In addition, a guide unit 34 which configures an outer diameter side of the arc-shaped transport path A of the U-shaped transport path is assembled in a rear opening/closing cover 17 illustrated in FIG. 3, and the rear opening/closing cover 17 configures a transport path opening/closing mechanism for externally exposing a portion of the jammed sheet P in the arc-shaped transport path A since the rear opening/closing cover 17 is mounted in an openable and closable manner.

Furthermore, the transport mechanism 11 has an auto sheet feeder (ASF) and a paper feed unit.

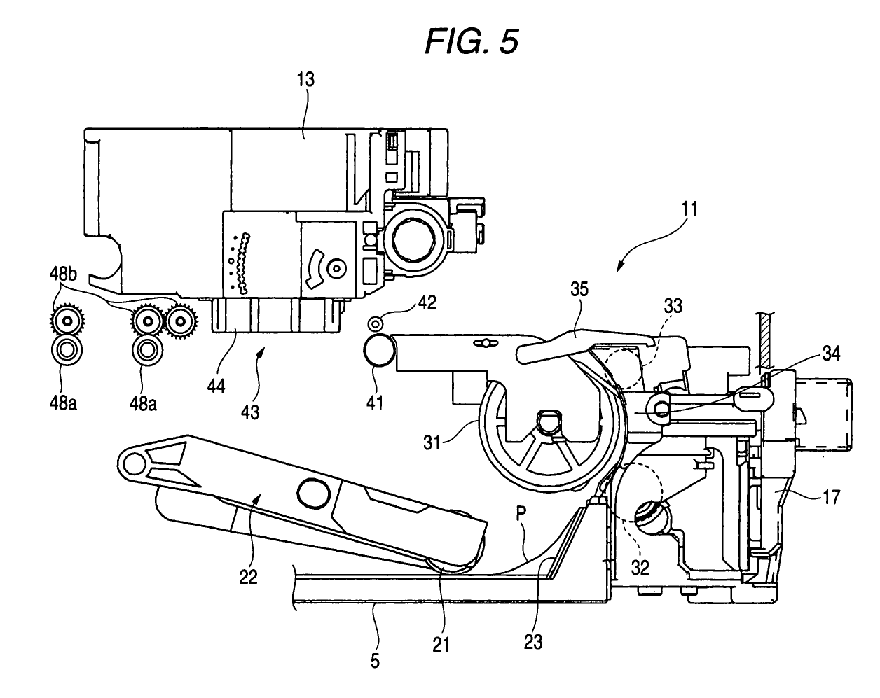

The auto sheet feeder, as shown in FIG. 5, includes a feed unit 22 for feeding one of the several sheets P laminated in the sheet cassette 5 into an inlet of the arc-shaped transport path A disposed at the rear side of the device, an intermediate roller 31 and an assist roller 33 mounted in the arc-shaped transport path A for transporting the sheet P introduced by the feed unit 22 to a paper feed roller 41 and a driven roller 42 which are disposed at a proximal position of the print head 44, and the guide unit 34 for controlling the transporting direction of the sheet P transported along the outer circumferential of the intermediate roller 31 configuring the inner diameter side of the arc-shaped transport path A with a predetermined gap to an arc-shape which reaches an outlet of the arc-shaped transport path A.

By inserting the sheet P between the intermediate roller 31 which is the driving roller and the assist roller 33 which is the driven roller, the sheet P is transported. At the upstream side of the assist roller 33, a retard roller 32 for preventing the several sheets P from being introduced into the arc-shaped transport path A is provided.

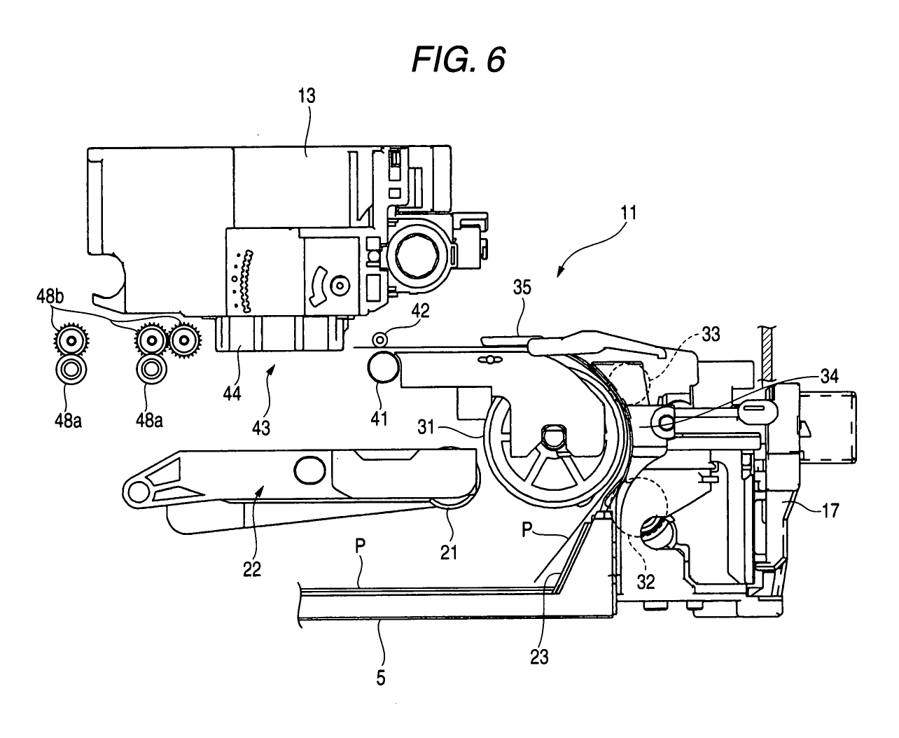

The paper feed unit, as shown in FIG. 6, transports the sheet P, which is transported from the arc-shaped transport path A, to a platen 91 including a platen surface (process reference surface) 91a disposed at the downstream side thereof, by the paper feed roller 41 and the driven roller 42 disposed on the linear transport path B (see FIG. 7).

In the present embodiment, the driven roller 42 presses and biases the upper surface of the sheet P onto the paper feed roller 41 which is the driving roller contacting the lower surface of the sheet P, thereby transporting the sheet P.

In addition, in the outer case 4 as shown in FIG. 7, a print process mechanism 43 including the print head 44 is mounted as a process mechanism for printing an image such as a character or a figure onto the sheet P which is transported onto the platen surface 91a of the platen 91. The sheet P which is printed by the print process mechanism 43 is sandwiched and transported by an ejection roller 48 which is the driving roller and a star wheel 48b which is the driven roller and is ejected to the ejection tray 6 at the outlet of the transport path.

The feed unit 22, as illustrated in FIGS. 4 and 5, is configured such that the rear end of a feed lever 25 including a pickup roller 21 at the front end thereof can rotate in a vertical direction in the figures by a support pin 24. This feed unit 22 allows the pickup roller 21 to contact the sheet P which is disposed at a highest side in the sheet cassette 5 by the vertical rotation of the feed lever 25.

When the inkjet printer 1 stops, the feed unit 22, as illustrated in FIG. 4, allows the feed lever 25 to be substantially maintained in a horizontal direction such that the pickup roller 21 is maintained to be separated from the sheet P in the sheet cassette 5.

In addition, at the time of feeding the sheet, as illustrated in FIG. 5, the pickup roller 21 presses the sheet P at the highest side in the sheet cassette 5 by the downward rotation of the feed lever 25 about the support pin 24, and the sheet P in the sheet cassette 5 contacts a sloped friction pad 23 by the rotation of the pickup roller 21 and separated by a friction force and the strength of the intermediate portion of the sheet P to be introduced into the arc-shaped transport path A one by one.

At this time, the retard roller 32 rotates in a counterclockwise direction in FIG. 5 and applies power to the sheet P toward the sheet cassette 5. By this configuration, for example, even if a lower sheet P is fed together, the retard roller 32 returns the lower sheet to the sheet cassette 5 by a friction force between the retard roller 32 and the lower sheet P. As a result, each sheet is separated and transported to the arc-shaped transport path, and then fed to the processor after transported while sandwiched between the intermediate roller and the assist roller.

When the print starts by the print process mechanism 43, as illustrated in FIG. 6, the feed lever 25 returns to an original horizontal state.

At the upper side of the guide unit 34, an auxiliary guide member 35 is provided together with the assist roller 33 for sending the transported sheet P toward the linear transport path B.

The rear end of the auxiliary guide member 35 is rotatably supported to the guide unit 34 and the front end thereof freely rotates.

Moreover, as illustrated in FIG. 6, the auxiliary guide member 35 presses the sheet P, which is transported from the arc-shaped transport path A to the linear transport path B, downward by its own weight, and guides the sheet P to the front side of the inkjet printer 1 along the linear transport path B.

The paper feed roller 41 and the driven roller 42 are disposed at the front side of the device separated from the outlet of the arc-shaped transport path A (downstream end of the guide unit 34) by a predetermined distance, and, as illustrated in FIG. 6, sandwiches the sheet P which is transported from the arc-shaped transport path A to the linear transport path B to transport the sheet P to the lower side of the print process mechanism 43 which is a print position. Furthermore, by controlling the rotation amount of the paper feed roller 41, the sheet P can be positioned with respect to the print process mechanism 43.

As illustrated in FIG. 4, the print head 44 of the print process mechanism 43 has an ejection nozzle 46 for ejecting ink toward the sheet P. At the upstream side of the ejection nozzle 46 in the inkjet printer 1, a PW sensor 47 for detecting the sheet P and detecting the width of the sheet P is provided.

The PW sensor 47 detects the existence of the sheet P by irradiating light to the sheet P and detecting light reflected from the sheet P and detects the width of the sheet P by moving the carriage 13.

Furthermore, in the inkjet printer 1 according to the present embodiment, sheet detecting sensors for detecting the existence of the sheet P are provided at several places in the transport path. In this case, these sensors may be transmission sensors.

In addition, the inkjet printer 1 according to the present embodiment includes a gap adjusting mechanism (APG: auto platen gap mechanism) 51 for adjusting a gap between the platen surface 91a and the print head 44, in order to perform a printing process on the sheets P having different thicknesses or the like.

The gap adjusting mechanism 51, as illustrated in FIGS. 7 through 10, includes transmission gears 55 provided on the ends of the pair of carriage shafts 53 and 53 for movably supporting the carriage 13 in the width direction of the sheet P, a cam 57 which includes a cam surface 57b protruded from a portion of the outer circumferential surface of a cylindrical portion 57a and is integrally formed with the transmission gear 55, a ring-shaped cam receiver 59 which is supported at the side of the printer main body to contact the outer circumferential surface of the cam 57, a gap adjustment wheel train 61 (see FIG. 2) for inputting a rotation force to the transmission gear 55, and a gap adjustment motor 63 for rotating the gap adjustment wheel train 61. On the other hand, the carriage shafts 53 and 53 are supported movably up and down and biased to the side of the cam receiver 59.

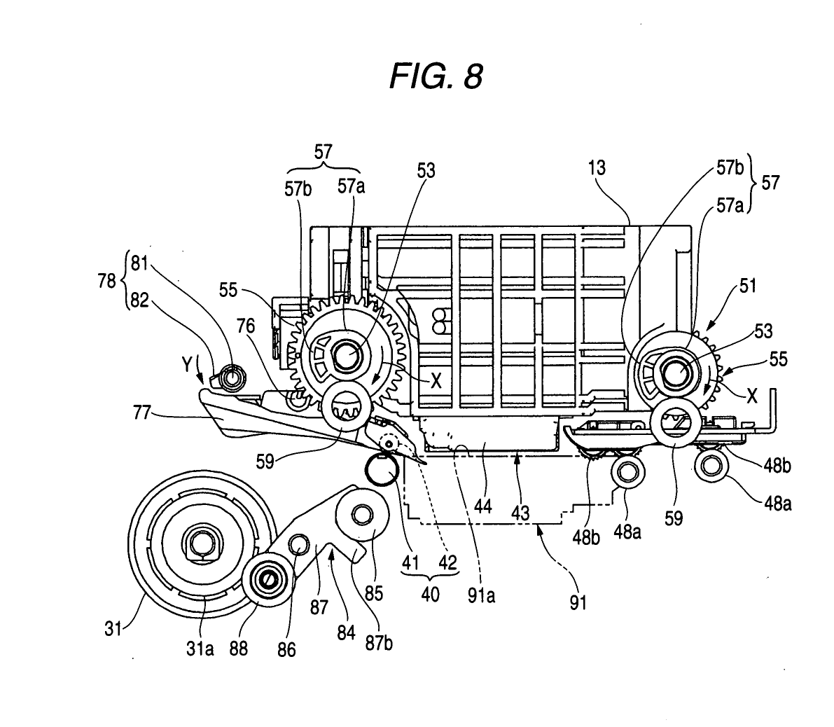

In the gap adjusting mechanism 51 having the above-mentioned configuration, when the rotation force output from the gap adjustment motor 63 is input to the transmission gear 55 through the gap adjustment wheel train 61 and the transmission gear 55 rotates by a predetermined angle in a direction indicated by an arrow X of FIG. 7, as illustrated in FIG. 8, by putting the cam surface 57b of the cam 57 on the cam receiver 59, the carriage shafts 53 move upward. By the upward movement of the carriage shafts 53, the print head 44 of the print process mechanism 43 integrally rises with the carriage 13 and thus the gap PG between the platen surface 91a of the platen 91 and the print head 44 of the print process mechanism 43 widens.

The cylindrical portion 57a of the cam 57 adjusts the gap PG between the platen 91 and the print head 44 to a minimum by the contact with the cam receiver 59 and is used when printing a thinnest sheet P among the sheets which can be printed.

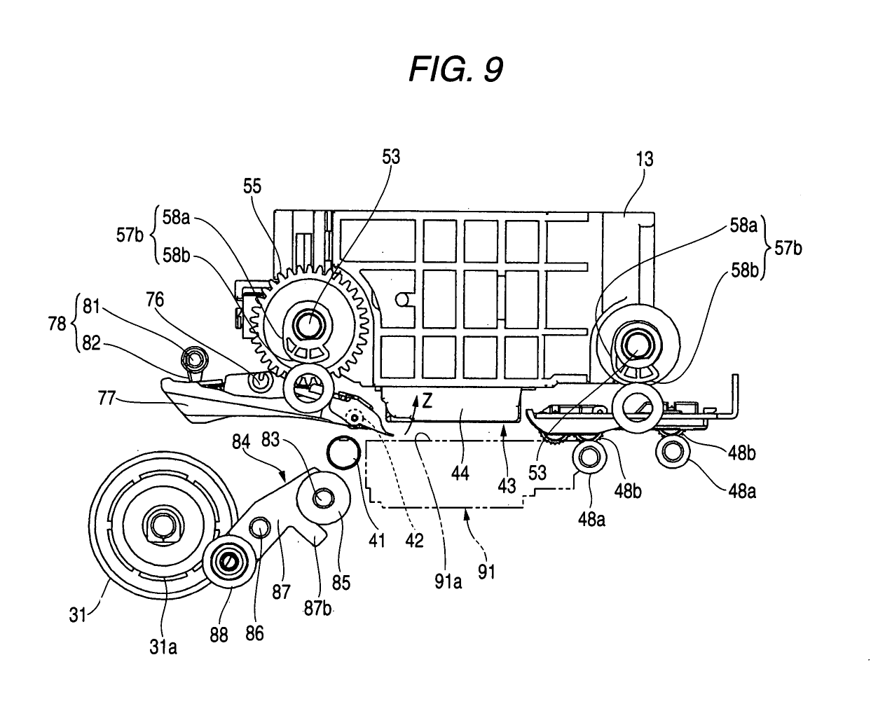

As illustrated in FIG. 9, the cam surface 57b of the cam 57 includes a slope portion 58a of which the protrusion amount is gradually changed from the rotation center and an arc portion 58b having a maximum protrusion amount of the slope portion 58a. The slope portion 58a is used for adjusting the gap when printing the sheet P having a different thickness, such as a postcard, or a CD-ROM, and the arc portion 58b is used when the gap PG between the platen 91 and the print head 44 is adjusted to a maximum when the paper jam is generated.

In addition, in the inkjet printer 1 according to the present embodiment, the paper feed roller 41 is attached to a sheet feed shaft 71 illustrated in FIG. 3, and rotationally driven by the wheel train (gear train) which is connected with the end of the paper feed shaft and perfoms rotation transmission.

The outer circumferential surface of the sheet feed shaft 71 is fixed with a pulley 72 having a large diameter. Furthermore, a pulley 74 having a small diameter is provided at the output shaft of a paper feed motor (PF motor) 73 which is disposed below the left side of the inkjet printer 1, and a timing belt 75 is stretched over the pulley 74 and the pulley 72 having the large diameter. In order words, the paper feed roller 41 rotates by the paper feed motor 73.

As illustrated in FIG. 8, the driven roller 42 paired with the paper feed roller 41 is rotatably mounted on the front end (fluctuation end) of a fluctuation arm 77 which is rotatably supported by a support shaft 76, and usually biased to maintain a contact state in which the driven roller 42 presses and contacts the paper feed roller 41.

Moreover, in the present embodiment, as illustrated in FIG. 8, a roller release mechanism 78 is provided which fluctuates and displaces the front end of the fluctuation arm 77 upward and retreats the driven roller 42 in a direction separated from the paper feed roller 41 in cooperation with the gap adjustment mechanism when the gap between the print head 44 and the platen 91 is adjusted by driving the gap adjustment motor 63.

The roller release mechanism 78 is constructed by forming a release protrusion 82 for pushing down the rear end of the fluctuation arm 77 and fluctuating the front end of the fluctuation arm 77 upward when the rotation amount of a rotation axis 81 reaches a predetermined angle, on the outer circumferential surface of the rotation axis 81 which rotates in a direction indicated by an arrow Y of FIG. 8 by the rotation of the gap adjustment motor 63.

Accordingly, when the release protrusion 82 pushes down the rear end of the fluctuation arm 77 by the rotation of the rotation axis 81, as illustrated by an arrow Z of FIG. 9, the front end of the fluctuation arm 77 is fluctuated and displaced upward and the driven roller 42 is released from the paper feed roller 41.

In addition, in the inkjet printer 1 according to the present embodiment, the rotation force input from the paper feed motor 73 which also functions as a driving source of the paper feed roller 41 to the sheet feed shaft 71 through the pulley 74, the timing belt 75, and the pulley 72 having the large diameter is transmitted to the intermediate roller 31 and an ejection roller 48a through a wheel train (now illustrated) connected to the sheet feed shaft 71.

Here, a one-direction clutch mechanism 84 for transmitting the power only when the paper feed motor 73 positively rotates is interposed between the wheel train connected to the sheet feed shaft 71 and the intermediate roller 31.

As illustrated in FIGS. 7 to 10, the one-direction clutch mechanism 84 according to the present embodiment includes a relay gear 85 which is rotatably supported to a pivot 83 and receives the rotation force of the paper feed roller 41, a fluctuation lever 87 of which the middle portion is rotatably supported by a pivot 86 disposed between the relay gear 85 and the intermediate roller 31, a planet gear 88 which is rotatably supported to one end of the fluctuation lever 87 through a torque limiter and is engaged with a gear 31a fixed to the intermediate roller 31, and a transmission gear 89 which is disposed on the pivot 86 such that their center axes are identical to each other, fluctuates the engaged planet gear 88 in a direction which is engaged with or released from the gear 31a of the intermediate roller 31 along the direction of the rotation force received from the relay gear 85, and transmits the rotation force to the gear 31a of the intermediate roller 31.

When the paper feed roller 41 rotates in a direction in which the sheet P is normally transported (that is, when the paper feed motor 73 positively rotates), the transmission gear 89 transmits the rotation force to the gear 31a of the intermediate roller 31 through the planet gear 88, while the engaged state is maintained by biasing the planet gear 88 in a direction which is engaged with the gear 31a of the intermediate roller 31.

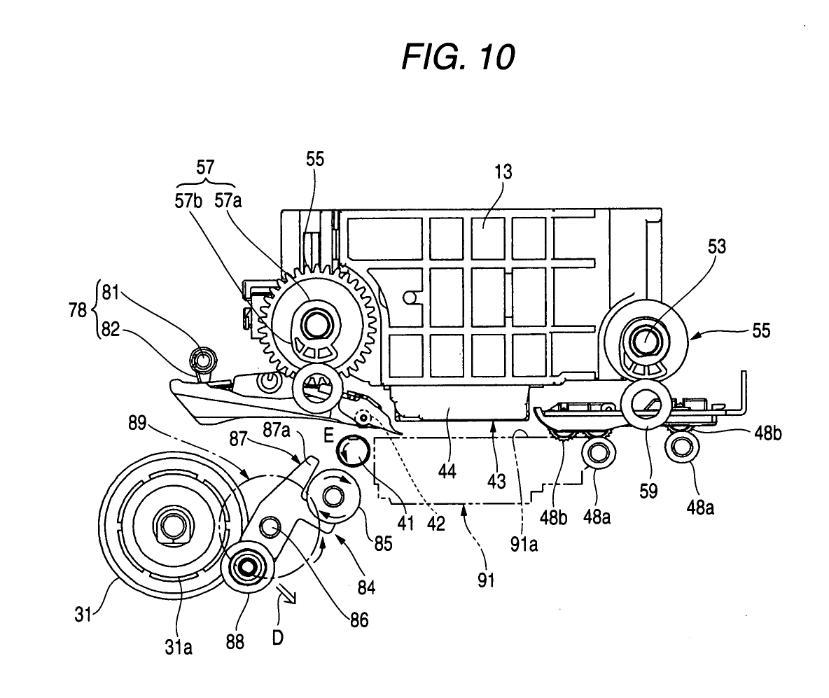

When the paper feed roller 41 is negatively driven by negatively driving the paper feed motor 73 as illustrated by an arrow E of FIGS. 7 and 10, the transmission gear 89 biases the planet gear 88 in a direction which is separated from the gear 31a of the intermediate roller 31 (a direction indicated by an arrow D illustrated in FIG. 10) to release the engaged state, the planet gear 88 idles and the rotation force cannot be transmitted to the gear 31a of the intermediate roller 31. Accordingly, the power transmission to the intermediate roller 31 through the one-direction clutch mechanism 84 is blocked.

Furthermore, the paper feed motor 73 positively rotates and the planet gear 88 may be biased through the transmission gear 89 in a direction which is engaged with the gear 31a of the intermediate roller 31, such that the one-direction clutch mechanism 84 returns to an original state which can transmit the power to the intermediate roller 31.

In addition, the fluctuation range of the planet gear 88 is defined by locking a pair of engagement units 87a and 87b which is provided at the other end of the fluctuation lever 87 to the pivot 83.

Moreover, in the inkjet printer 1 according to the present embodiment, a control unit (not illustrated) for controlling the operations of the units monitors the signal of the PW sensor 47 provided in the print head 44 or the sheet detecting sensor provided in the transport path at the time of the feed operation and the print process.

In addition, in the control unit, a detecting unit for detecting the existence of the sheet P in the transport path and detecting the paper jam of the sheet P in the transport path based on these detected signals detects the operation stop during the carriage 13 moves. When the detecting unit detects the paper jam, the control unit determines that the paper jam is generated and performs the process according to the flowchart illustrated in FIG. 11.

Furthermore, the detecting unit according to the present embodiment detects the paper jam of the sheet P in the transport path by detecting the operation stop during the carriage 13 movement. However, the paper jam may be detected, for example, by detecting the movement amount of the sheet P.

In other words, each one pass of the carriage 13 which is during a print process, it is determined whether the carriage (CR) 13 stops (step S101), and, when the stop of the carriage 13 is not detected, it is determined that one-pass print is normally completed by the movement of the carriage 13 in the width direction of the sheet and the process returns to the step S101. A sensor for detecting whether a paper is existed or not may be provided in the transport path and it may be determined that the paper jam is generated when the sensor does not detect a change from a state with paper to a state without paper within a predetermined period. Further, if a paper feeding motor or a carriage motor is a DC motor, it may be determined that the paper jam is generated when the current value becomes high unusually.

In the step S101, when the stop of the carriage 13 is detected, it is determined that the paper jam is generated and thus the process progresses to the step S102. In the step S102, the gap adjusting mechanism (APG) 51 operates such that the cam surface 57b of the cam 57 is put on the cam receiver 59, as illustrated in FIG. 7, and the gap PG between the platen surface 91a of the platen 91 and the print head 44 of the print process mechanism 43 is set to a maximum position.

Furthermore, since the roller release mechanism 78 operates in cooperation with the gap adjusting mechanism 51, in the step S102, in addition to the gap adjustment due to the gap adjusting mechanism 51, the driven roller 42 is separated from the paper feed roller 41 by the operation of the roller release mechanism 78 and thus the operation of releasing the sandwiching of the sheet P is performed.

Next, in the step S103, since the paper feed motor (PF motor) 73 negatively rotates and thus the planet gear 88 of the one-direction clutch mechanism 84 illustrated in FIG. 10 is fluctuated in a direction indicated by an arrow D, which is separated from the gear 31a of the intermediate roller 31, to release the engaged state, the power transmission between the paper feed roller 41 and the intermediate roller 31 is blocked.

Next, the display process, such as a process of switching on an indicator for notifying a user that paper jam error is generated, is performed and thus the printer stops (step S104).

In other words, when the paper jam is generated in the device, the gap adjusting mechanism 51 and the roller release mechanism 78 automatically operate, and the power transmission between the paper feed motor 73 and the intermediate roller 31 is blocked by negatively driving the paper feed motor 73 and the generation of the paper jam error is then notified.

As described above, according to the inkjet printer 1 according to the present embodiment, when the paper jam is generated in the device, the gap adjusting mechanism 51 automatically operates and the gap PG between the platen surface 91a and the print head 44 widens to a maximum.

Accordingly, when the rear opening/closing cover 17 which is the transport path opening/closing mechanism is opened and the sheet P is pulled out, the print head 44 is not contaminated by a problem that the jammed sheet P rubs against the print head 44 of the print process mechanism 43 and thus the jammed sheet P can be stably removed.

Furthermore, in the inkjet printer 1 according to the present embodiment, the gap adjusting mechanism 51, which is automatically operated by the control unit when the paper jam is generated, can process the sheets P having different thicknesses as well as remove the paper jam. Accordingly, since a new mechanism for removing the paper jam need not be further provided, the configuration of the device is not complicated and the jammed sheet P can be easily removed with the low cost.

In addition, when the jammed sheet P is pulled out, since the driven roller 42 is separated from the jammed sheet P by the roller release mechanism 78 which operates in conjunction with the gap adjusting mechanism 51 and thus the sandwiching of the sheet P is opened, the jammed sheet P can be easily pulled out with a small operation force. Furthermore, when the jammed sheet P is pulled out, a piece of sheet does not remain in the device.

Accordingly, it is possible to easily remove the jammed sheet P and thus the treatment and repairability of the inkjet printer 1 can be improved when the paper jam is generated.

Moreover, in the inkjet printer 1 according to the present embodiment, even when the intermediate roller 31 contacts the jammed sheet P, after it is determined that the paper jam is generated, the negative rotation of the paper feed motor 73 is automatically performed and the power transmission between the paper feed motor 73 and the intermediate roller 31 is blocked by the one-direction clutch mechanism 84 so that it becomes easy to rotate. Accordingly, when the jammed sheet P is pulled out, a load is not applied to the paper feed motor 73 and thus the sheet P is pulled out with a small operation force.

In addition, in the state that the power transmission is blocked by the one-direction clutch mechanism 84, the rotation force applied to the intermediate roller 31 by a friction force with the sheet P which is pulled out is not reversely transmitted to the paper feed motor 73 and thus it is possible to avoid a problem that the circuits in the device are damaged by the power generation of the paper feed motor 73. Thus, the reliability and durability of the inkjet printer 1 can be improved.

Moreover, the read/write processing device according to the present invention is not limited to the inkjet printer described in the above-mentioned embodiment. For example, the present invention may be applied to various devices having the transport path for transporting the paper, such as a copier, a facsimile, a scanner, a magnetic information reading device, a magnetic information recording device, and a paper money changing machine. The read/write unit may be a magnetic head for reading magnetic information.

What is claimed is:

1. A read/write processing device comprising:
a transport path, adapted to transport a medium therethrough;
a read/write unit, adapted to read or write data on the medium and provided at a part of the transport path;
a transport mechanism, provided with a first feeding roller and a pressing member adapted to transport the medium to the read/write unit while the pressing member presses the medium toward the first feeding roller;
a gap adjusting mechanism, operable to adjust a gap between the read/write unit and the medium in the trasnsport path;
a medium release mechanism, operable to release the mdium from the first feeding roller and the pressing member;
a detector, operable to detect a jam of the medium in the transport path; and
a controller, operable to control the gap adjusting mechanism to wide the gap, when the detector detects the jam.

2. The read/write processing device according to claim 1, further comprising a transport path opening and closing mechanism, operable to open and close a part of the transport path to remove the jammed medium therefrom.

3. The read/write processing device according to claim 1, wherein the medium release mechanism is cooperated with the gap adjusting mechanism.

4. A read/write processing device comprising:
a transport path, adapted to transport a medium therethrough;
a read/write unit, adapted to read or write data on the medium and provided at a part of the transport path;
a transport mechanism, provided with a first feeding roller and a pressing member adapted to transport the medium to the read/write unit while the pressing member presses the medium toward the first feeding roller;
a medium release mechanism, operable to release the medium from the first feeding roller and the pressing member;
a detector; operable to control the medium release mechanism to release the medium, when the detector detects the jam.

5. The read/write processing device according to claim 4, further comprising a read/write unit support mechanism, operable to move the read/write unit to be away from the transport path, wherein the controller controls the read/write unit support mechanism when the detector detects the jam.

6. The read/write processing device according to claim 5, wherein the roller release mechanism is cooperated with the read/write unit support mechanism.

7. The read/write processing device according to claim 4, wherein the pressing member is a first pressing roller which can rotate.

8. The read/write processing device according to claim 7, wherein the transport mechanism further comprises:
a second feeding roller and a second pressing roller, disposed at an upstream side of the first feeding roller and the first pressing roller, and adapted to transport the medium to the first feeding roller and the first pressing roller while the second pressing roller presses the medium toward the second feeding roller;
a motor, operable to rotate in a first direction to drive the first feeding roller and in a second direction opposite to the first direction;
a clutch mechanism, operable to transmit power to the second feeding roller, when the motor is rotated in the first direction, and wherein
the controller rotates the motor in the second direction so as to shut off transmitting the power to the second feeding roller, when the detector detects the jam.

9. The read/write processing device according to claim 4, further comprising:
a cassette, disposed at a lower side of a front face of the apparatus to store the medium; and
a ejection tray, disposed above the cassette to receive the medium processed by the processor, wherein
the transport path is a U-shaped transport path to connect the cassette with the ejection tray.

10. The read/write processing device according to claim 4, wherein the read/write unit comprises a print head adapted to print information on the medium.
